(19) United States
(12) Patent Application Publication
(10) Pub. No.: US 2005/0080687 A1
(43) Pub. Date: Apr. 14, 2005

(54) Method for purchasing from a virtual inventory

(76) Inventor: Michael Self, Fort Lauderdale, FL (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/849,595

(22) Filed: May 20, 2004

Related U.S. Application Data
(60) Provisional application No. 60/509,617, filed on Oct. 8, 2003.

(51) Int. Cl. G06F 17/60

(52) U.S. Cl. 705/28

(57) ABSTRACT

A method for purchasing from a virtual inventory, including creating a virtual inventory card representative of at least one product manufactured by a manufacturer, providing the virtual inventory card to a retailer from the manufacturer, presenting the virtual inventory card to a consumer from the retailer, obtaining the virtual inventory card by the consumer, contacting the manufacturer by the consumer via a computer network, presenting the consumer with a virtual inventory of the at least one product representative of the virtual inventory card, selecting the at least one product from the virtual inventory by the consumer, and manufacturing the at least one product based on the step of selecting, and transmitting the at least one product to the consumer.

### CROSS-REFERENCES TO RELATED APPLICATION

This application claims the benefit of U.S. Provisional Application Ser. No. 60/509,617, filed on Oct. 8, 2003, entitled METHOD FOR MARKETING VIRTUAL INVENTORY.

### TECHNICAL FIELD

The present invention relates to a method for the creation of virtual representations of manufacturing processes and, in particular, inventory and manufacturing environments that may be associated with on-demand manufacturing processes.

### BACKGROUND OF THE INVENTION

Traditionally, retail stores in the business of selling goods to consumers purchase such goods from a manufacturer or wholesaler. The purchased goods are then delivered to individual retail stores where the goods must be stored for subsequent sale to customers. For stores dealing in relatively bulky inventory or a large quantity of inventory items, having sufficient storage space may cause a problem as the cost or availability of storage space for inventory may be limited. Due to the costs involved in procuring sufficient storage space, some retail stores may have certain goods that can be purchased only through the customer placing an order, with the purchased goods being delivered to the customer within several days. Further, some retail stores may decline to sell the goods altogether.

If a retail store chooses to have an item only available for order by a customer, often the customer may decline to purchase the item because of the delayed delivery of the item. The customer may decline either because they wish to have the item right away or because making a purchase resulting with nothing physically in their possession at the time of purchase may leave the customer feeling empty-handed, thereby failing to satisfy the purchase “impulse” of some buyers.

This failure to satisfy an impulse-buyer's need to have an item in their immediate possession signifying the purchase is also present with traditional mail-order or internet based purchases. Although such mail-order or internet-based retail stores may not have the inventory storage problems described above, their marketing exposure in traditional retail locations may be limited, and their delayed delivery also fails to satisfy the needs of an impulse-buyer.

There is a need for a method which will enable a manufacturer to sell its goods through retail stores and subsequently to consumers that will not pose any inventory storage problems for the retail stores, as well as satisfy the needs of an impulse buyer to have a representative item in their possession signifying their purchase for an item to be delivered within a few days of purchase, and to go home and select the item from a larger inventory display on an internet web page, after an impulse purchase.

### SUMMARY OF THE INVENTION

The present invention eliminates the above-mentioned needs by providing a method for marketing virtual inventory of products that would be either economically impractical or undesirable to carry in stock in a retail store or at the manufacturer, while still satisfying the “impulse” buying decision of the consumer through the purchase of a “virtual inventory card,” which can later be redeemed for the actual product.

The present invention implements the use of a virtual inventory card, which is a credit-card sized plastic card. The virtual inventory card represents an actual product for which the virtual inventory card can later be redeemed, and is analogous to a ticket or bill of sale.

In accordance with the present invention, there is a manufacturer of products, a retailer, and a consumer. The manufacturer supplies the retailer with virtual inventory cards either by direct sale to the retailer, or alternatively, the retailer is billed depending on the amount of virtual inventory cards that are actually sold. The retailer then sells a virtual inventory card to a consumer. Once purchased, the virtual inventory card allows the consumer to redeem the actual product by following instructions for redemption, which are displayed on the virtual inventory card itself. The purchase of the virtual inventory card, which represents the actual product purchased, satisfies the consumer's impulse buy as they have a physical item in their possession representing the purchase.

In one embodiment, the instructions on the virtual inventory card direct the purchasing consumer to log on to a website in which the consumer can validate the virtual inventory card, select the specific product for which the virtual inventory card was purchased, and the product is then either sent to the consumer directly from the manufacturer's stock or the product is manufactured upon receipt of the order, and the product is subsequently sent to the consumer.

In accordance with the present invention, there is provided a method for purchasing from a virtual inventory, including creating a virtual inventory card representative of at least one product manufactured by a manufacturer, providing the virtual inventory card to a retailer from the manufacturer, presenting the virtual inventory card to a consumer from the retailer, obtaining the virtual inventory card by the consumer, contacting the manufacturer by the consumer via a computer network, presenting the consumer with a virtual inventory of the at least one product representative of the virtual inventory card, selecting the at least one product from the virtual inventory by the consumer, and manufacturing the at least one product based on the step of selecting, and transmitting the at least one product to the consumer.

### BRIEF DESCRIPTION OF THE FIGURES

FIG. 1a is a diagrammatic illustration of the method of the present invention.

FIG. 1b is an illustration of front view of a virtual inventory card.

FIG. 2 is an illustration of the back view of a virtual inventory card.

FIG. 3 is a screen shot of the validation screen of the preferred embodiment of the present invention.

FIG. 4 is a screen shot of the validation screen of the preferred embodiment of the present invention.

FIG. 5 is a screen shot of the product selection area of the preferred embodiment of the present invention.

FIG. 6 is a screen shot of the narrowing product selection areas of the preferred embodiment of the present invention.

FIG. 7 is a screen shot of the narrowing product selection areas of the preferred embodiment of the present invention.

FIG. 8 is a screen shot of the quantity selection screen of the preferred embodiment of the present invention.

FIG. 9 is a screen shot of the cart update screen of the preferred embodiment of the present invention.

FIG. 10 is a screen shot of the checkout screen of the preferred embodiment of the present invention.

FIG. 11 is a screen shot of the customer information screen of the preferred embodiment of the present invention.

FIG. 12 is a screen shot of the customer information screen of the preferred embodiment of the present invention.

FIG. 13 is a screen shot of the verification screen of the preferred embodiment of the present invention.

FIG. 14 is a screen shot of the verification screen of the preferred embodiment of the present invention.

### DETAILED DESCRIPTION OF THE PREFERRED EMBODIMENT

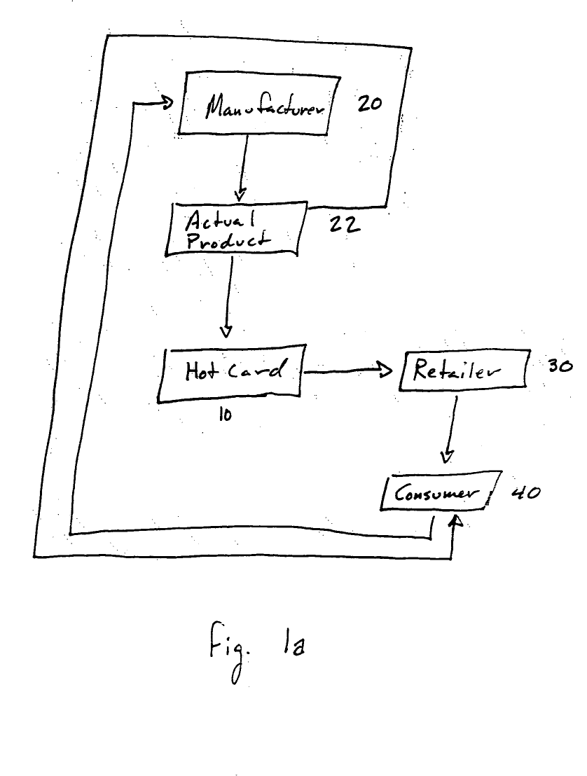

Referring now to FIG. 1a, a preferred embodiment of the present invention includes a manufacturer 20 of an actual product 22, such as an item or good generally available for sale. Actual product 22 is preferably a type of good that is either impractical or undesirable to maintain in stock or at the physical location of a retailer 30. Instead of selling or distributing actual product 22 directly to retailer 30, the use of a virtual inventory card 10 is implemented as a representation of the sale of actual product 22. virtual inventory card 10 is thus provided to retailer 30 for sale or other distribution to consumer 40. Retailer 30 provides for the sale and/or marketing of actual product 22 to a consumer 40 via virtual inventory card 10. Consumer 40 can then utilize virtual inventory card 10 through manufacturer 20 to redeem actual product 22.

Referring now to FIG. 1b, a preferred embodiment of virtual inventory card 10 is illustrated including a product advertisement 14 displayed on a first side of virtual inventory card 10. Product advertisement 14 is preferably a graphical representation of actual product 22, produced by manufacturer 20.

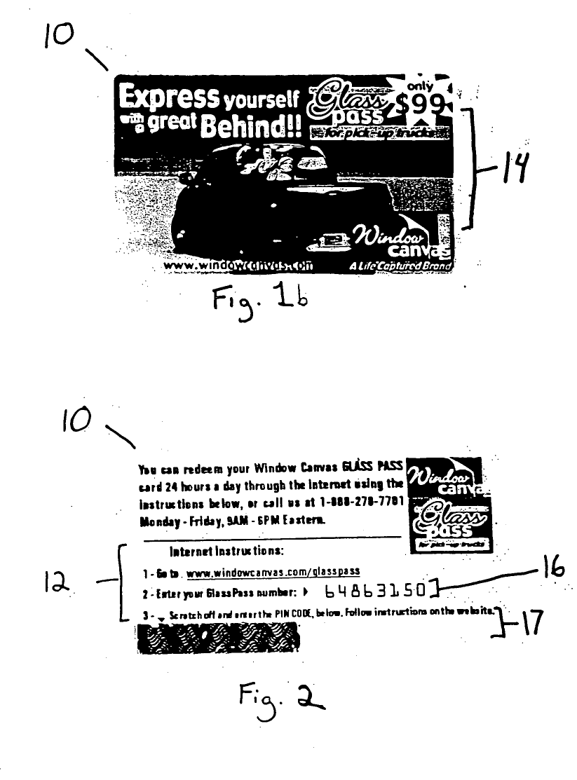

Referring to FIG. 2, virtual inventory card 10 further displays redemption instructions 12 on a second side of virtual inventory card 10, redemption instructions 12 describing the steps consumer 40 must follow to order and obtain actual product 22 from manufacturer 20. Virtual inventory card 10 can further include a validation code 16 and a PIN code 17. As is well known in the art, codes, such as validation code 16 and a PIN code 17, are used to keep track of accounts and order information.

Virtual inventory card 10 is either sold directly from manufacturer 20 to retailer 30 for a monetary amount, or, alternatively, manufacturer 20 may supply virtual inventory card 10 to retailer 30 where retailer 30 will be billed thereafter by manufacturer 20 for each virtual inventory card 10 that is sold to a consumer 40.

Once in possession of virtual inventory card 10, retailer 30 markets for sale the product represented by the virtual inventory card 10 to consumer 10. Retailer 30 displays an actual product 22, a facsimile of product 22 or other representation of product 22. Upon purchase of virtual inventory card 10 by consumer 40, consumer 40 may follow the redemption instructions 12 to obtain the actual product 22 to which virtual inventory card 10 represents.

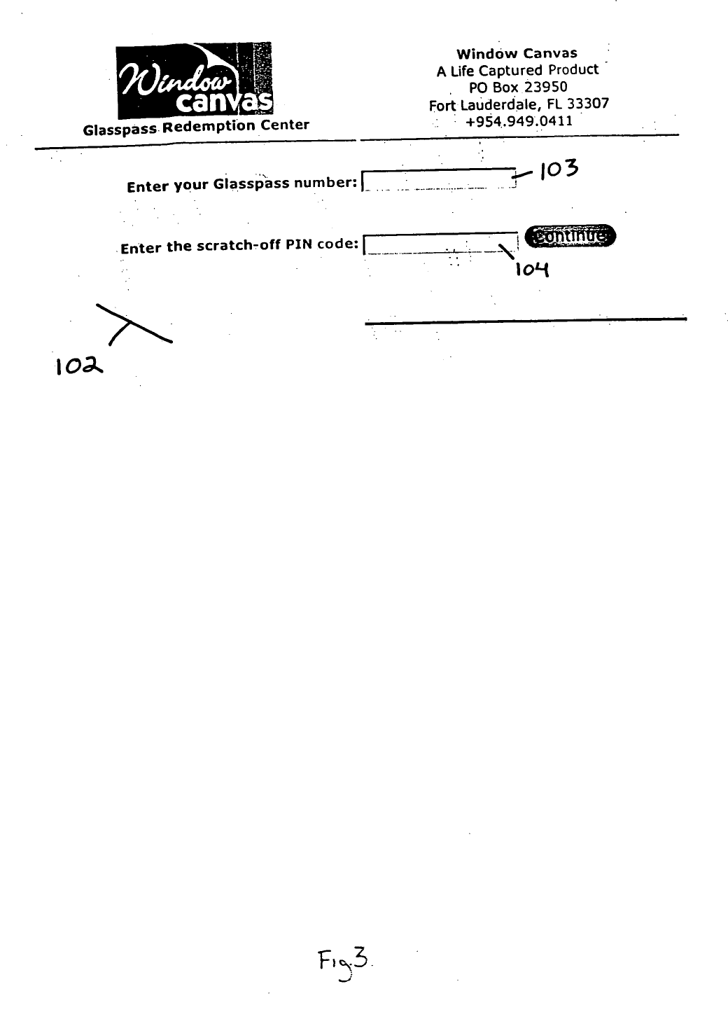

Redemption instructions 12 may include directing consumer 40 to log on to a specified website on a computer network, such as the Internet, as in FIG. 3, where consumer 40 will validate the purchase of virtual inventory card 10 by entering validation code 16 (shown as “Glasspass number”) and PIN code 17 displayed on virtual inventory card 10. Upon validation of virtual inventory card 10 by the computer network, consumer 40 may specify actual product 22 that the purchase of virtual inventory card 10 embodies, and the manufacturer 20 may either send actual product 22 to consumer 40 directly from the stock inventory of manufacturer 20, or manufacturer 20 may manufacture actual product 22 upon redemption by consumer 40 of virtual inventory card 10 to a consumer's specifications, e.g., style, size, color and the like.

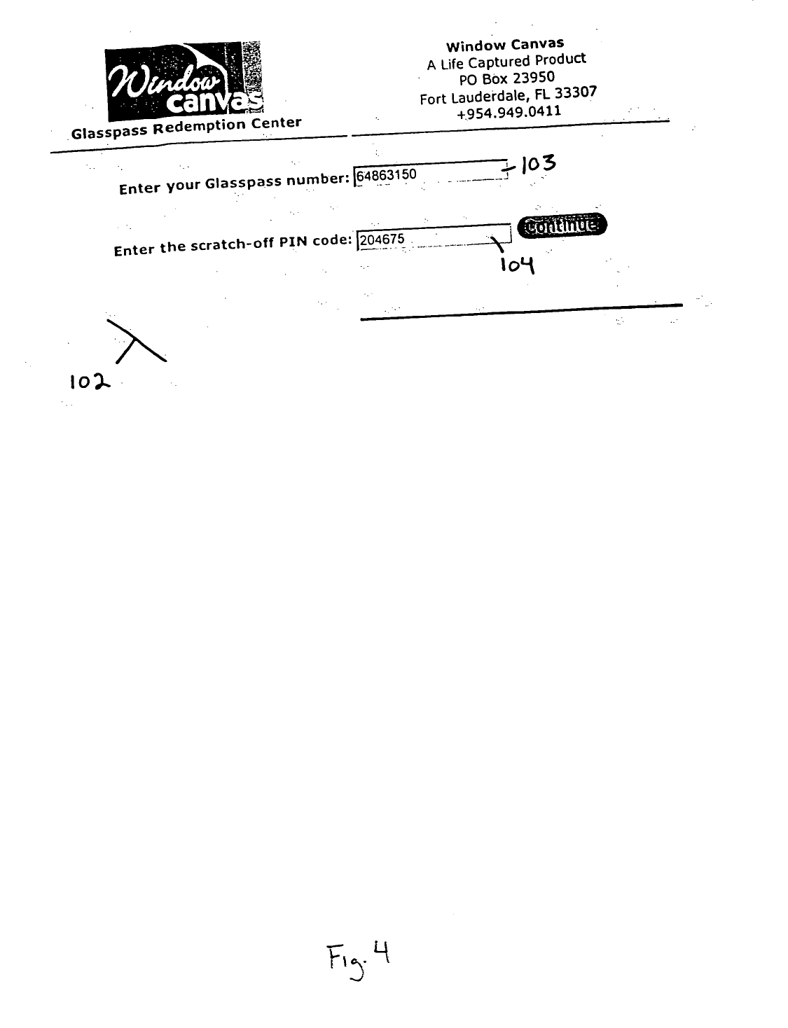

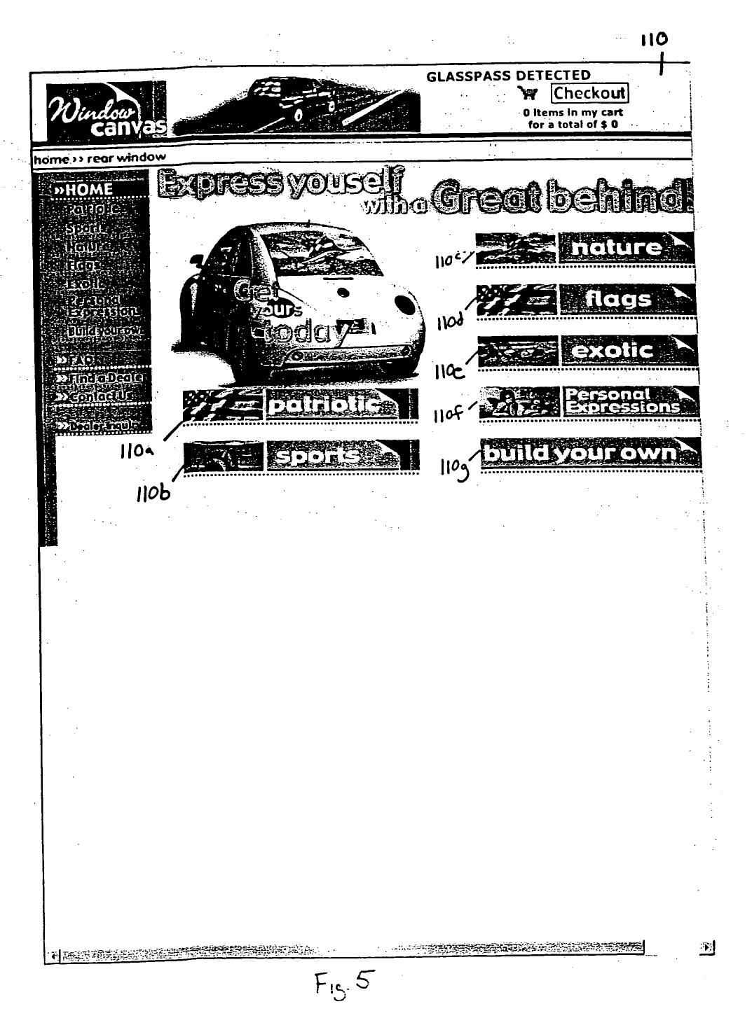

An example of a preferred embodiment of the validation process includes consumer 40 logging onto a computer network, such as the Internet, that is specified on virtual inventory card 10, as shown in FIGS. 3 and 4. Consumer 40 is prompted to enter validation code 16 into validation code entry field 103, and PIN code 17 into PIN code entry field 104 on a validation screen 102. The codes are then validated by the computer network, most desirably by comparing validation code 16 and PIN code 17 to a predetermined list of authentic codes stored on the computer network, thereby allowing consumer 40 to enter a product selection area 110 on the computer network, as shown in FIG. 5.

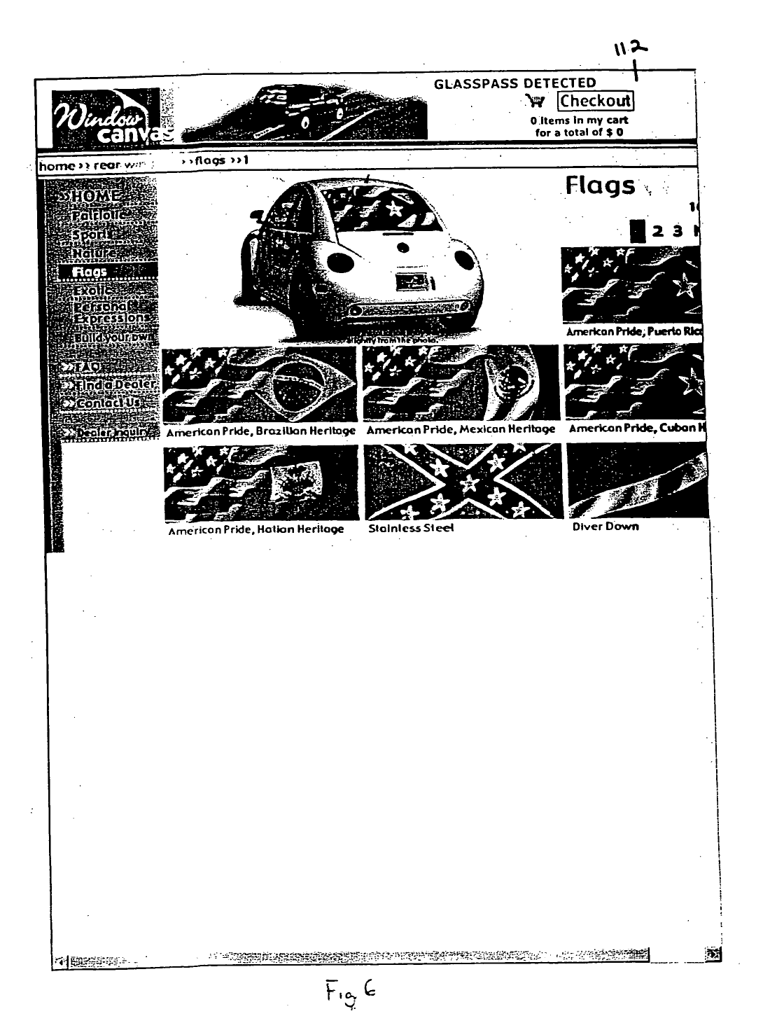

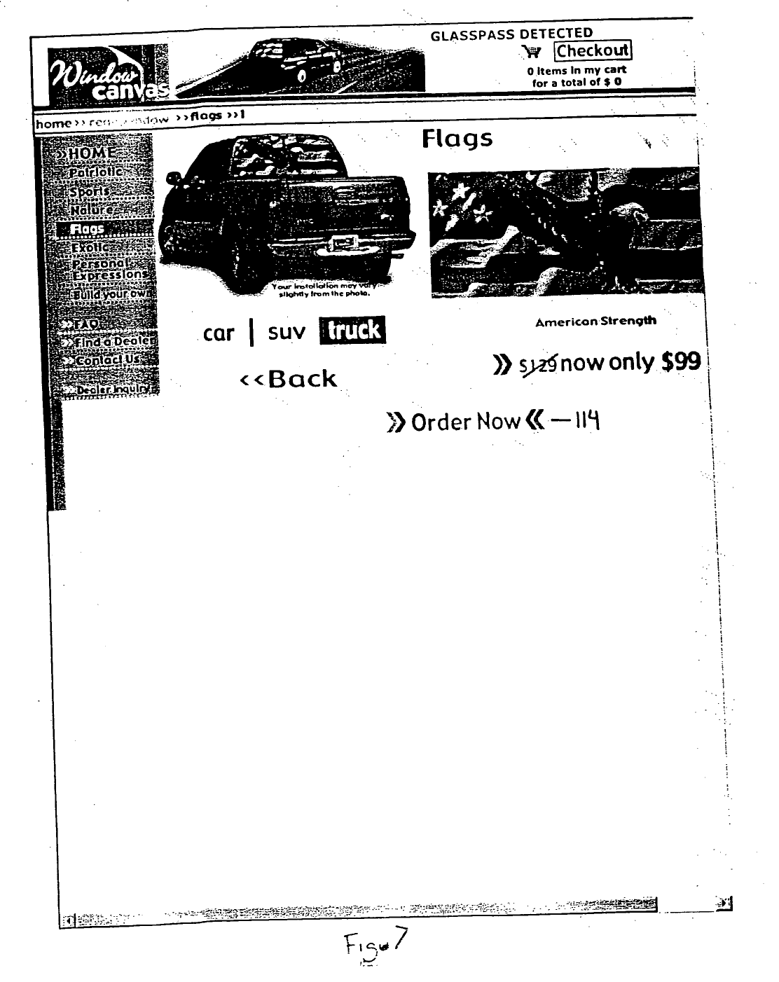

Referring now to FIG. 5, consumer 40 then proceeds to select the desired product variation, preferably from a menu of products to select from, such as patriotic version 110a, sports version 110b, nature version 110c, flags version 110d, exotic version 110e, personal expressions version 110f, or build your own version 110g (wherein consumer 40 creates a version that is not a predetermined selection), of actual product 22 from the product selection area 110, which preferably includes narrowing product selection areas 112, illustrated in FIG. 6, that allow consumer 40 to specify with greater detail actual product 22 that is desired by consumer 40, as shown in FIGS. 6 and 7.

By way of example, in FIG. 5, consumer 40 may select flags 110d, which allows consumer 40 to then choose a specific flag from a selection of flags presented, as shown in FIG. 6. Once consumer 40 has selected actual product 22, consumer may select the “Order Now” option 114 from the narrowing product selection areas 112 as shown in FIG. 7.

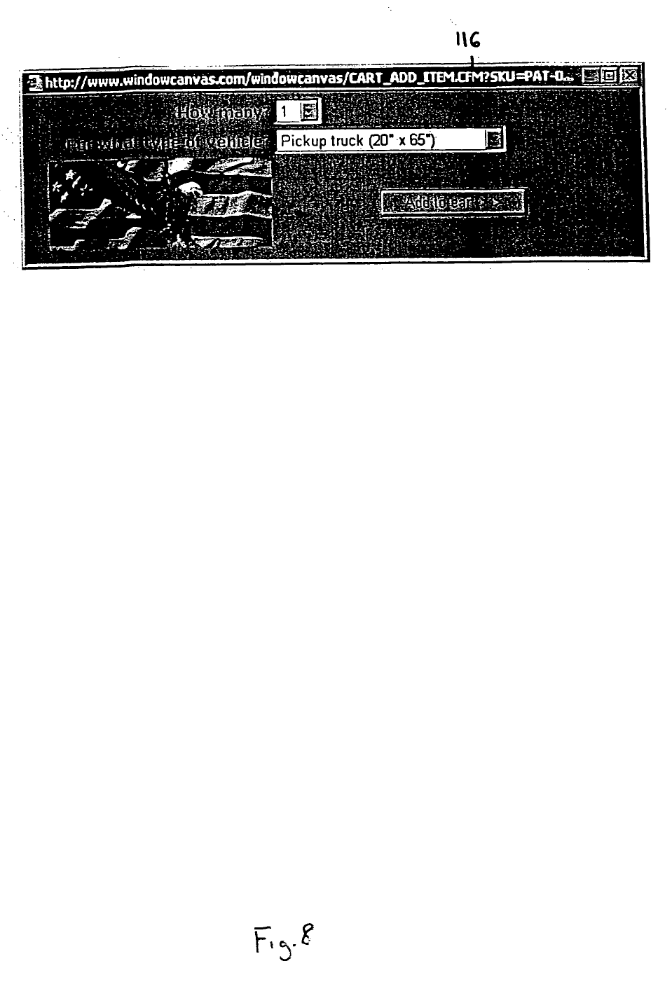

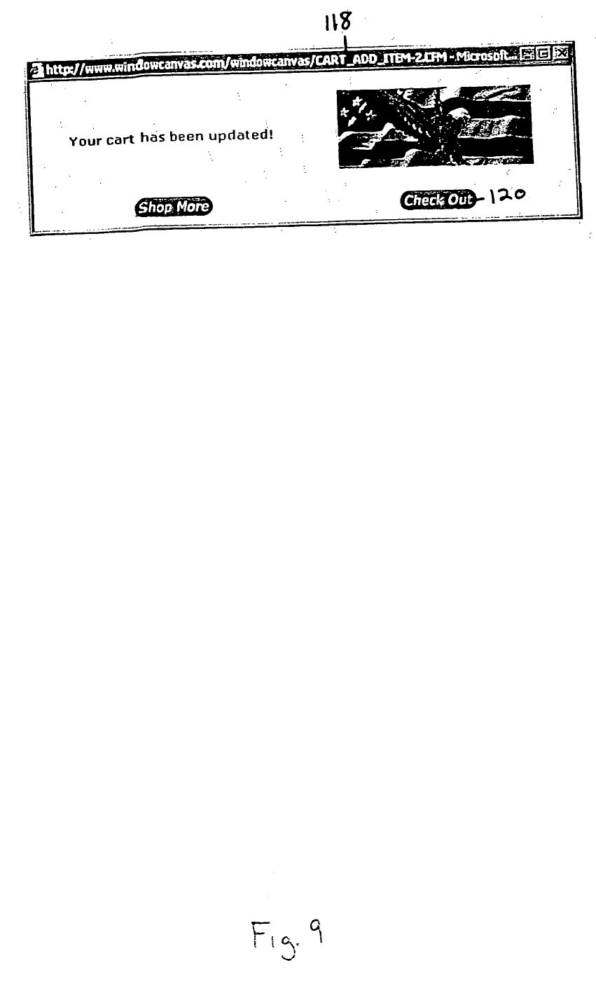

Selecting “Order Now” option 114 leads to a quantity selection screen 116 in which consumer 40 may choose the quantity of actual product 22 desired, and any remaining specifications necessary for the completion of ordering actual product 22, as illustrated in FIG. 8. Such remaining specifications necessary for the completion of ordering actual product 22 include the type of application, such as type of vehicle. Once the quantity selection of actual product 22 has been completed, consumer 40 will receive confirmation that they have made a selection by a cart update screen 118, illustrated in FIG. 9.

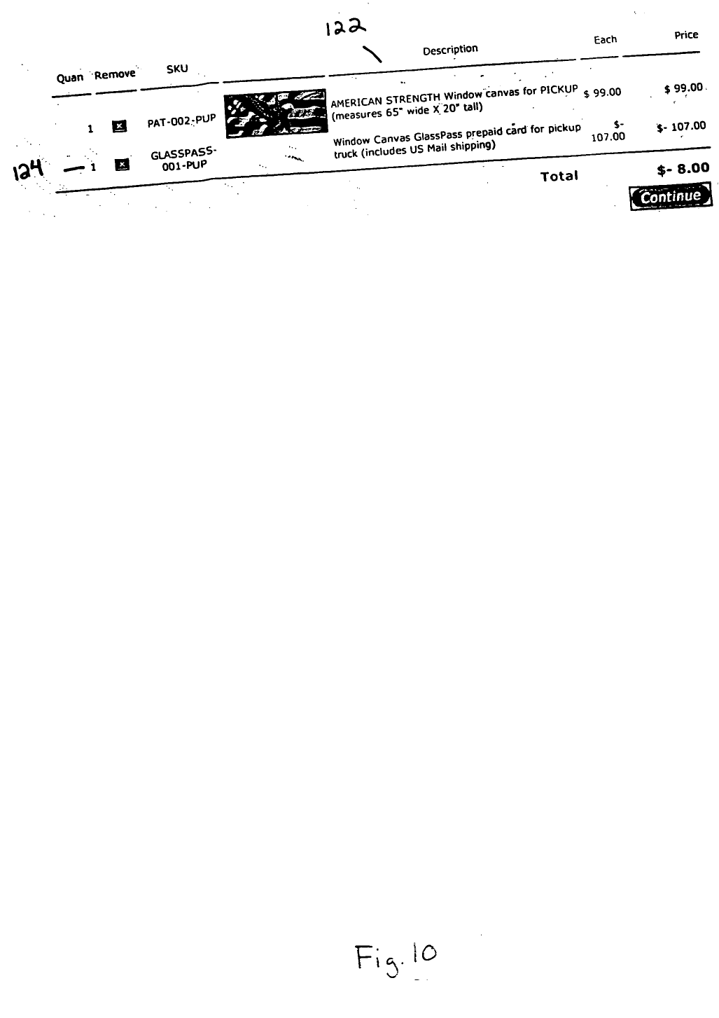

Selecting the check out option 120 from cart update screen 118 of FIG. 9 directs consumer 40 to a checkout screen 122, as shown in FIG. 10.

Referring now to FIG. 10, checkout screen 122 includes the product selection of actual product 22, which is displayed, including the quantity and price of actual product 22, and the monetary credit 124 from purchase and validation of virtual inventory card 10 is also displayed.

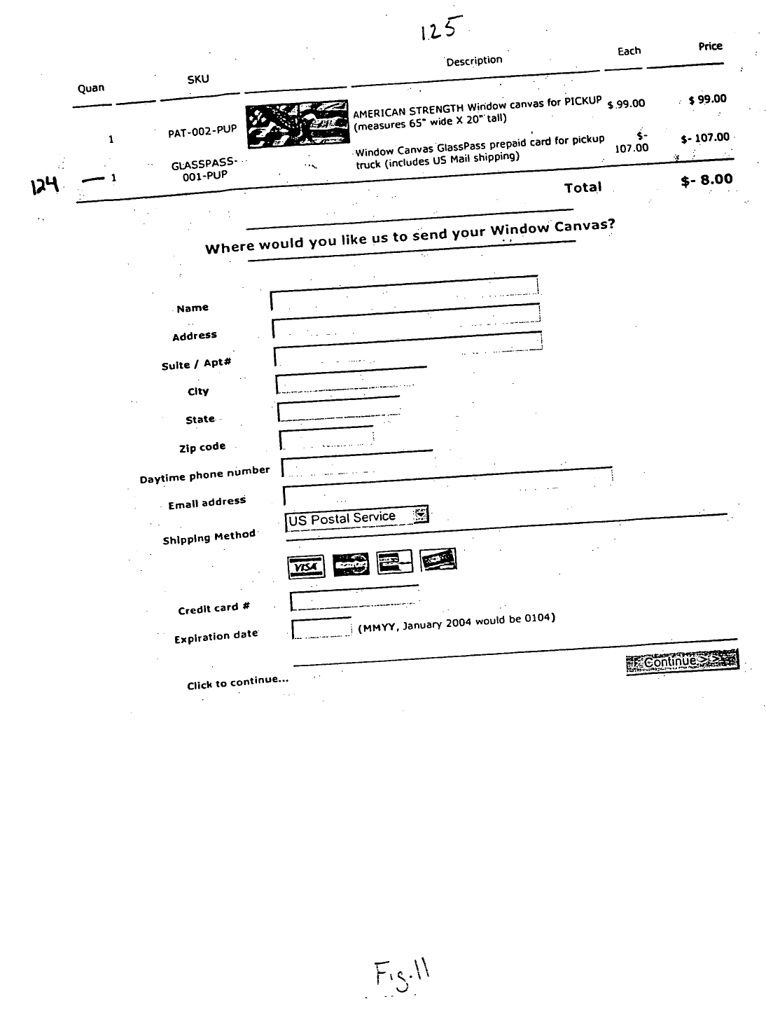

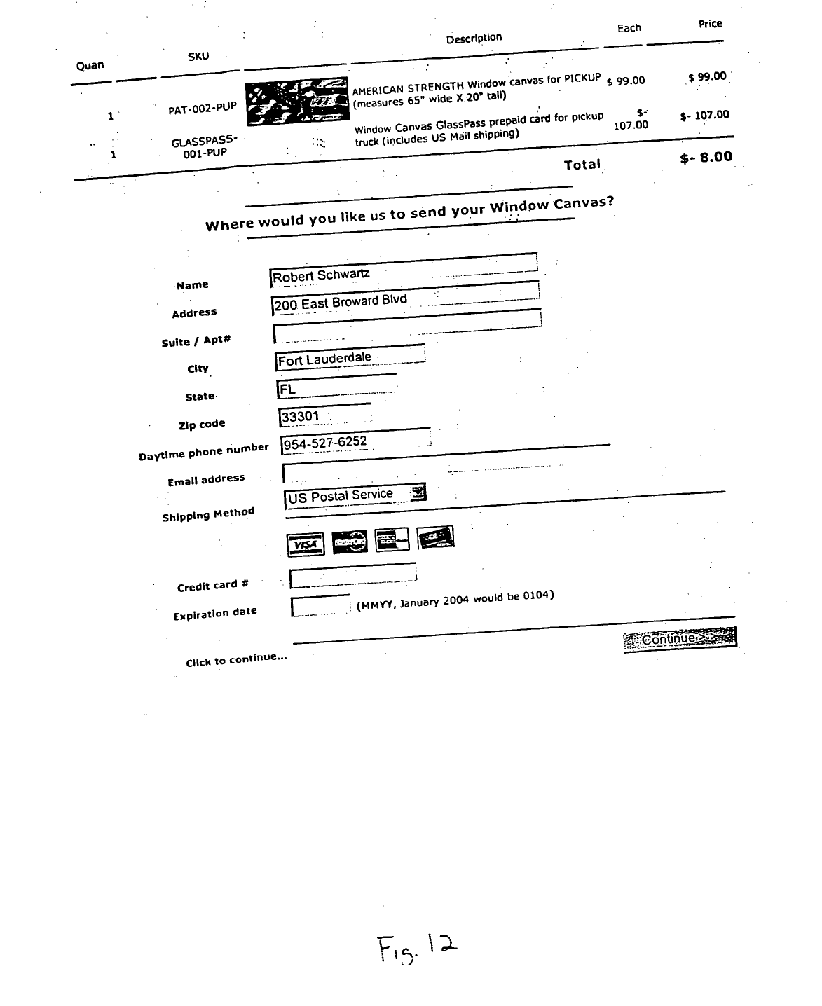

Referring now to FIGS. 11 and 12, proceeding from checkout screen 122 of FIG. 10, consumer 40 is then prompted to input a mailing address into a customer information screen 125. Since virtual inventory card 10 has been validated prior to the ordering process and monetary credit 124 from virtual inventory card 10 preferably includes shipping charges, there may be no need to input any credit card or other payment information, as shown in FIGS. 11 and 12. In the event there is an insufficient monetary amount available from redemption of virtual inventory card 10, consumer 40 may then enter billing information into the designated information fields, also shown in FIGS. 11 and 12.

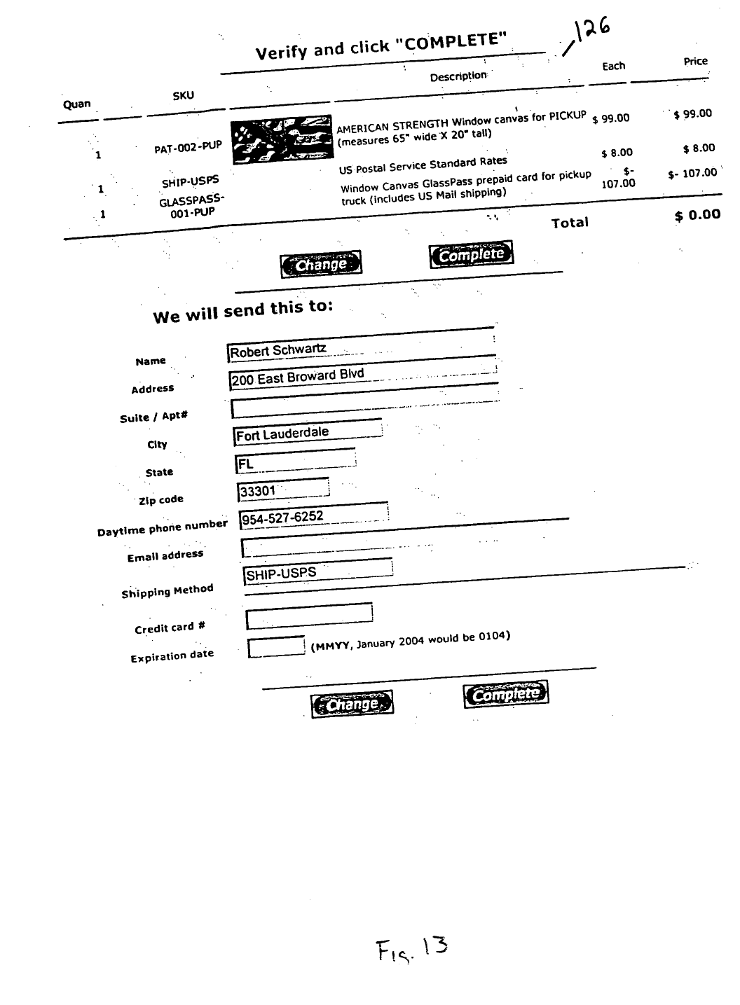

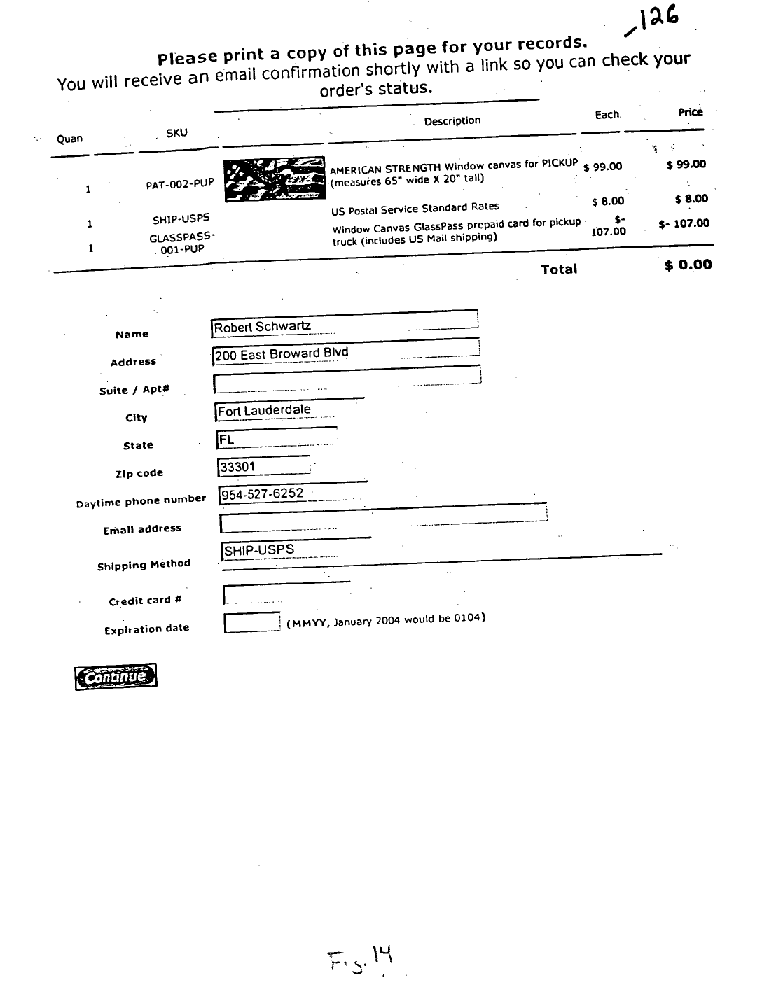

Upon completion of the entry of the shipping and/or mailing address of consumer 40 and any required billing information, consumer 40 may then subsequently verify and complete the order in a verification screen 126, as illustrated in FIGS. 13 and 14.

Upon verification of shipping information, manufacturer 20 constructs actual product 22 as ordered/specified by customer, thus no actual inventory is required by either manufacturer 20 or retailer 30, and ships, sends or otherwise transmits the actual product 22 to the designated recipient.

Although only a few exemplary embodiments of the present invention have been described in detail above, those skilled in the art will readily appreciate that numerous modifications as to the exemplary embodiments are possible without materially departing from the novel teachings and advantages of this invention. Accordingly, all such modifications are intended to be included within the scope of this invention as defined in the following claims.

1. A method for purchasing from a virtual inventory, comprising:
creating a virtual inventory card representative of at least one product manufactured by a manufacturer;
providing said virtual inventory card to a retailer from said manufacturer;
presenting said virtual inventory card to a consumer from said retailer;
obtaining said virtual inventory card by said consumer;
contacting said manufacturer by said consumer via a computer network;
presenting said consumer with a virtual inventory of said at least one product representative of said virtual inventory card;
selecting said at least one product from said virtual inventory by said consumer; and
transmitting said at least one product to said consumer.

2. A method according to claim 1 wherein said at least one product based on said step of selecting is manufactured by said manufacturer.

3. The method according to claim 1 wherein said virtual inventory card is presented to said consumer at a retailer location.

4. The method according to claim 1 wherein said consumer is presented with a virtual inventory of said at least one product representative of said virtual inventory card after said virtual inventory card is validated.

5. The method according to claim 3 wherein said virtual inventory card is validated by said manufacturer.

6. A method for manufacturing, comprising:
providing a virtual inventory card representative of at least one product manufactured by a manufacturer to a consumer;
contacting said manufacturer by said consumer via a computer network;
validating said virtual inventory card by said manufacturer;
displaying a virtual inventory of said at least one product representative of said validated virtual inventory card to said consumer;
selecting said at least one product from said virtual inventory by said consumer; and
transmitting said at least one product to said consumer.

7. A method according to claim 6 wherein said at least one product based on said step of selecting is manufactured.

8. A method for manufacturing, comprising:
providing a virtual inventory card representative of at least one product manufactured by a manufacturer to a consumer;
contacting said manufacturer by said consumer via a data transmission network;
validating said virtual inventory card by said manufacturer;
displaying a virtual inventory of said at least one product representative of said validated virtual inventory card to said consumer;
selecting said at least one product from said virtual inventory by said consumer; and
transmitting said at least one product to said consumer.

9. The method according to claim 8 wherein said data transmission network is a voice data transmission network.
